(19) United States
(12) Patent Application Publication
(10) Pub. No.: US 2008/0037167 A1
(43) Pub. Date: Feb. 14, 2008

(54) Forming a head with reduced pole tip recession

(76) Inventors: Eric W. Flint, San Jose, CA (US); Chemgye Hwang, San Jose, CA (US); Ning Shi, San Jose, CA (US); Yongjian Sun, San Jose, CA (US)

Correspondence Address: WAGNER MURABITO & HAO LLP, 123 Westridge Drive, Watsonville, CA, 95076, US

(21) Appl. No.: 11/502,070

(22) Filed: Aug. 9, 2006

(51) Int. Cl. G11B 5/187

(52) U.S. Cl. 360/122; 360/322; 29/603.01; 29/603.07; 360/125.01

(57) ABSTRACT

Embodiments of the present invention pertain to forming a head with reduced pole tip recession. According to one embodiment, a pole tip element is formed from a platinum containing material. During diamond like carbon (DLC) processing, hydrogen and hydrogen containing compounds are removed from a vacuum plasma processing environment that contains the head so that an amount of material that is removed from the pole tip element and other non-platinum containing elements associated with the head are approximately the same.

### TECHNICAL FIELD

Embodiments of the present invention relate to manufacturing read heads. More specifically, embodiments of the present invention relate to forming read heads with recession in the pole tip that is less than the recession that results from conventional methods of manufacturing heads.

### BACKGROUND

Direct access storage devices (DASD) have become part of every day life, and as such, expectations and demands continually increase for greater speed for manipulating data and for holding larger amounts of data. To meet these demands for increased performance, the mechanical assembly in a DASD device, such as the Hard Disk Drive (HDD) has undergone many changes.

FIGS. 1A and 1B provide general information about the components and sub assemblies of an HDD. More specifically, FIG. 1A depicts the relationship of components and sub assemblies of HDD 110 and a representation of data tracks 136 recorded on the disk's surface 135. FIG. 1B shows a similar HDD 110, but with all of its components in an isometric exploded view. The components are assembled into base casting 113, which provides attachment and registration points for components and sub assemblies. Data is recorded onto the disk's surface 135 in a pattern of concentric rings known as data tracks 136. The disk's surface 135 is spun at high speed by means of a motor hub assembly 130. Data tracks 136 are recorded onto the disk's surface 135 by means of a magnetic head 156, which typically resides at the end of slider 155. An actuator 140 can be used to position the magnetic head 156 over the disk. Referring to FIG. 1B, in general, the motor-hub assembly 130 supports the disk stack 138 so that the disk's surface 135 can be spun adjacent to the slider 155 and thus allows the magnetic head 156 to read and write data tracks 136 on the disk's surface 135. FIG. 1A being a plan view shows only one head and one disk surface combination. One skilled in the art understands that what is described for one head disk combination applies to multiple head disk combinations. The embodied invention is independent of the number of head disk combinations.

As the industry demands that more and more data be written onto electronic recording medium, such as disks, it is becoming more and more imperative that the distance that a read sensor flies over the disk becomes smaller and smaller. The distance that a read sensor flies over a disk is commonly referred to as “fly height.”

What is commonly known in the art as the Wallace Spacing Loss (WSL) relationship indicates that the amplitude from reading a signal from a disk is directly related to the fly height. More specifically, the lower a sensor flies the weaker the signal that the sensor can read. Therefore, more data can be stored and later read from a disk with lower fly heights.

A series of magnetic read and write head assembly can be first formed on a substrate known as wafer. These heads can then be diced into sliders on which Air Bearing Surfaces (ABS) are formed, thus, enabling flight height control when put into an HDD. Prior Art FIG. 1C depicts a picture of a cross section bisecting a conventional giant magneto-resistive (GMR) read head produced by a Transmission Electron Microscope (TEM). The TEM picture 160 was produced after a sputter etch cleaning by an ABS protective carbon process had been performed. A slider containing the read device, such as a GMR, is placed into a vacuum chamber for the purpose of performing Diamond-Like Carbon (DLC) deposition on the ABS. Before performing such film deposition, a sputter etch, referred to as “sputter etch cleaning” or referred to just as an “etch,” is normally performed to clean the ABS surface with the GMR sensor being exposed.

The TEM picture 160 depicts a read head within the pole tip region which is to the right of the interface 168, also known as an Air Bearing Surface (ABS). The TEM picture also depicts a line 170 that indicates where the surface of a disk would be. The read head includes a sensor 162, also commonly known as the stripe, that is separated by Alumina gap (172 and 174) on each side next to the read sensor shields (176 and 178). The GMR read sensor itself 162 may include a GMR structure (182) with a free layer, a Co, Ni, and Fe containing alloys and a pinned layer with a stack of film laminates; and an antiferromagnetic pinning layer 180 made of platinum (Pt) containing alloys such as PtMn. The interface 168 of the read head at ABS and the surface of a disk 170 may be separated by a distance 166 that is conventionally around 10 nanometers. Due to recession of the antiferromagnetic pinning layer 180, the bottom surface of the sensor 162 is an additional distance 164 of approximately 6.9 nanometers resulting in a total distance of 16.9 nanometers, e.g., distance 166+distance 164. More specifically, because the PtMn pinning layer is recessed, in such case the sensing GMR structure may be left unpinned raising head instability issues. The term “pole tip recession” shall include recession of the antiferromagnetic pinning layer, sensor recession, and pinning layer recession.

The strength and stability of the signal that the sensor 162 could read from the surface of a disk 170 would be improved by reducing the sensor recession, e.g., distance 164, and making the interface 168 more planarized. The sensor recession cannot be measured by the conventional pole tip recession (PTR) optical and conventional surface profilometer measurements due to limited spatial instrument resolution, nor its origin has been determined by the prior art. Conventional PTR usually is a measurement of the relative elevation of shield assembly against nearest ABS pad. Such recession is measured against a neighboring giant magneto resistive (GMR) structure 182.

### SUMMARY OF THE INVENTION

Embodiments of the present invention pertain to forming a head with reduced pole tip recession. According to one embodiment, a pole tip element is formed from a platinum containing material. During diamond like carbon (DLC) processing, hydrogen and hydrogen containing compounds are removed from a vacuum plasma processing environment that contains the head so that an amount of material that is removed from the pole tip element and other non-platinum containing elements associated with the head are approximately the same.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A depicts a plan view of an HDD with cover and top magnet removed.

FIG. 1B depicts an isometric exploded view of an HDD.

FIG. 1C depicts a picture of a cross section of a conventional giant magneto-resistive (GMR) read head produced by a transmission electron microscope (TEM).

FIG. 2A depicts a conventional read head surface topography at the onset of sputter etch cleaning during the ABS carbon process.

FIG. 2B depicts a conventional read head surface topography after sputter etch cleaning has been performed.

FIG. 3 depicts several graphs illustrating different glancing angles and beam voltages that were used during sputter etch cleaning of NiFe coupons, according to various embodiments of the present invention.

FIG. 4 depicts two graphs illustrating different glancing angles and beam voltages that were used during sputter etch cleaning of real production sliders, according to various embodiments of the present invention.

FIG. 5 compares results obtained from the conventional art and various embodiments of the present invention.

FIG. 6 depicts a flowchart 600 for a method of forming a head with reduced pole tip recession, according to one embodiment FIG. 7 depicts a flowchart 700 for another method of forming a head with reduced pole tip recession, according to another embodiment.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

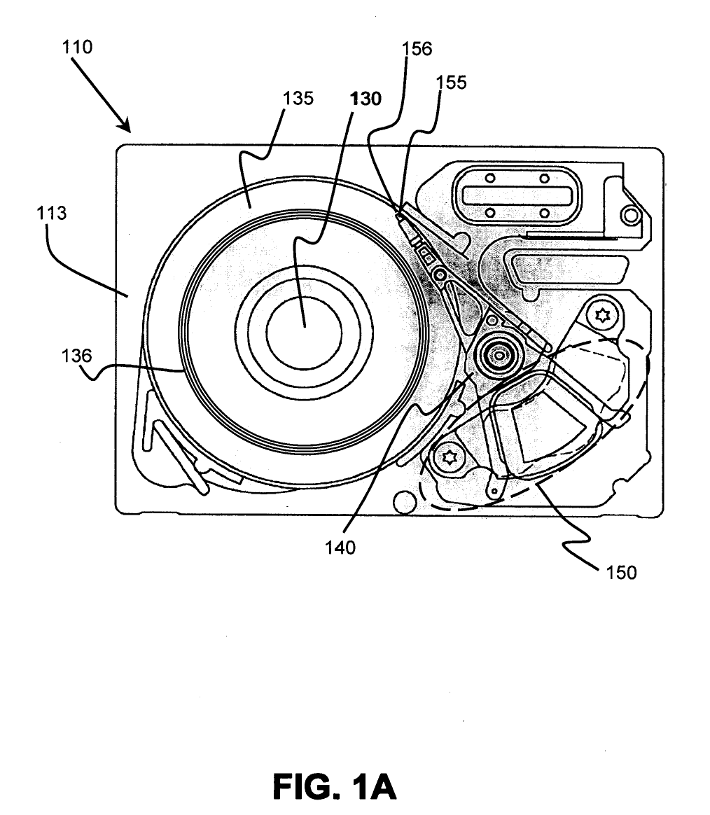

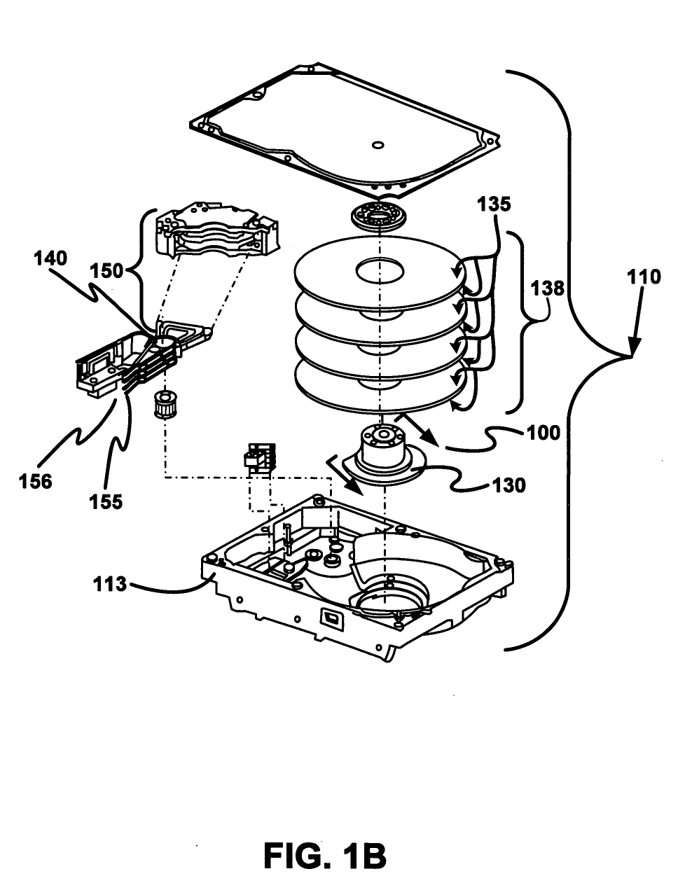

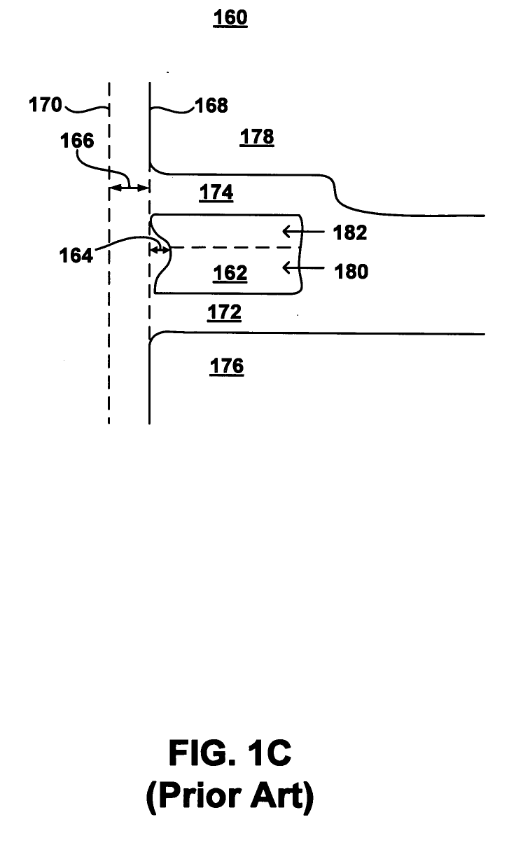

According to one embodiment, the antiferromagnetic pinning layer is made of a platinum containing material. In contrast, the adjacent GMR layers are made of a stack of materials with a major component being an iron containing material. For illustration purposes and lack of an objective way to utilize the true sensor materials in correct orientation, free layer NiFe is used to approximate this film stack in discussion as well as in an illustrative coupon experiment. The purpose is to aid understanding of the physical phenomena so to institute targeted solutions. Another way to justify the use of NiFe as a reference is that the GMR structure (182) is shown to have substantially similar etch removal as neighboring shields (176, 178) as shown in FIG. 1C, according to one embodiment.

As will be discussed in more detail, through research it was found that hydrogen, which for example can be from moisture in the air and various sources in forms of hydro-carbons, interacts with the platinum to form an active complex, for example, on the surface. This active complex is less stable than other materials associated with a head. Therefore, a sputter etch cleaning process will remove more material from the pinning layer than will be removed from the adjacent free layer, resulting in the pinning layer being recessed from the rest of the stripe. The “unpinned” or weakly “pinned” GMR near the ABS surface may be unstable thus producing heads with noisy signals.

The amount of active complex that is formed can be reduced by removing hydrogen from the environment in which the head is sputter etch cleaned during slider fabrication, thus, the GMR sensor ABS surface topography can be made smoother and less recessed, according to one embodiment. According to another embodiment, the amount of material removed from the pinning layer can be reduced by performing the sputter etch cleaning at a glancing angle that ranges from approximately 75 degrees, as will become more evident.

### Hydrogen and a Platinum Containing Material

Prior to being put into a vacuum, the material that the read head is made out of is in contact with moisture, e.g., H₂O, and other hydro-carbon in various upstream processes when the ABS is created during slider process and when the sensor itself was being made during parent wafer process, for example. Therefore hydrogen can be on, as well as in, the head assembly as micro contaminants. Also, residual hydrogen in a vacuum system can be very hard to be pumped out, and specially designed equipment is required. Furthermore, it was discovered through research that hydrogen interacts with platinum on the surface to form an active surface complex that is easily removed by energetic ions (sputter etch).

Another source of hydrogen is intrinsic to DLC process. Typically, during a run, a sputter etch cleaning is performed and subsequently an amount of DLC is deposited. DLC can also be a source for hydrogen and of hydro-carbon. For example, for DLC produced by ion beam technique, precursor gases used to generate carbon-containing plasma are usually CxHy. Examples of commonly used gases are CH₄, C₂H₂, C₂H₄. Some form of residual CH inevitably remains in the process chamber and reacts when a subsequent run is performed. DLC in general uses H to stabilize SP3 bond, a critical physical aspect for Diamond-like properties.

### Pole Tip Elements and Sputter Etch Cleaning

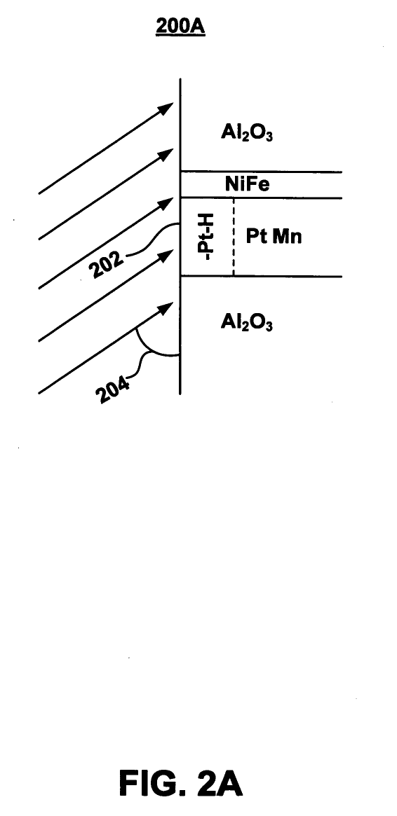

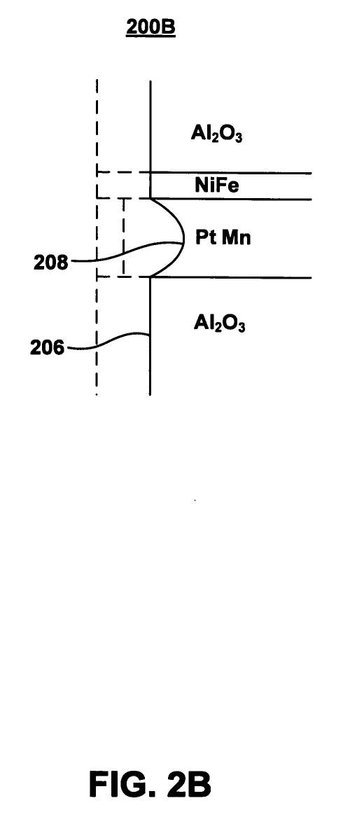

FIG. 2A depicts a conventional read head surface topography at the onset of sputter etch cleaning during the ABS carbon process. The conventional pole tip element 200A is a pole tip element at the onset of sputter etch cleaning, according to one embodiment. The pole tip element 200A includes platinum containing material, such as platinum manganese (PtMn). This includes the pinning layer. Hydrogen interacts with the platinum to form an active complex (Pt—H) at the surface 202. The formation of the active complex (Pt—H) at the surface 202 shall be referred to hereinafter as “surface effect.” The free layer is made of Nickel Iron (NiFe). The adjacent alumina, e.g., Al₂O₃, can be a sputter deposited material known as read gaps to electrically insulate and spatially separate a sensor from shields.

FIG. 2B depicts a conventional read head surface topography after sputter etch cleaning has been performed. The conventional pole tip element 200B is a pole tip element after the sputter etch cleaning has been performed. The sputter etch cleaning can be performed by conventional RF diode or by an Ion Beam (IB) source. In the case of IB etch, the incident beam angle can be tilted away from plane normal of the ABS surface for example as angle 204. As the sputter etch cleaning is performed the surface active complex (Pt—H) is energetically easier to be removed than the other stable materials, e.g., NiFe and Al₂O₃ and etc., resulting in a recessed pinning layer 208. The recession 208 may have a concave shape due to the corner 206 shadowing the effects of the sputter etch cleaning regardless vacuum etching techniques. In this case an IB etch is performed at an angle 204. This is commonly referred to as the “shadowing effect.”

### The Research

This section discusses how it was determined that platinum containing materials interact with hydrogen to form an active complex resulting in a pole tip element recession. Research was performed on what is commonly known as “coupons” where a full film of material of interest is pre-deposited and on real production sliders to analyze etch rates and etch rate differentials where real-life material such as material orientation and geometry are in place to interact. The former shall be referred to herein as the “coupon study” and the latter shall be referred to herein as the “real slider study.” What is commonly known as “bulk etch rate” can be determined by performing sputter etch cleaning on “coupons.”

A “coupon” can be a structure that sufficiently resembles a device that is being researched in order to test a change. For example, a read head typically includes a sensor, pinning and the reference free layers, etc., and read gaps and shields. However, in order to determine the effects from process conditions for example of varying the IB glancing angle and the beam voltage, coupons that include a pinning layer made of PtMn, for example, and a free layer made of NiFe, for example, may be used. The coupon may not include extraneous irrelevant structures. Beside as free layer material, NiFe is also the neighboring shield material. This makes etch rate comparison with NiFe much more relevant

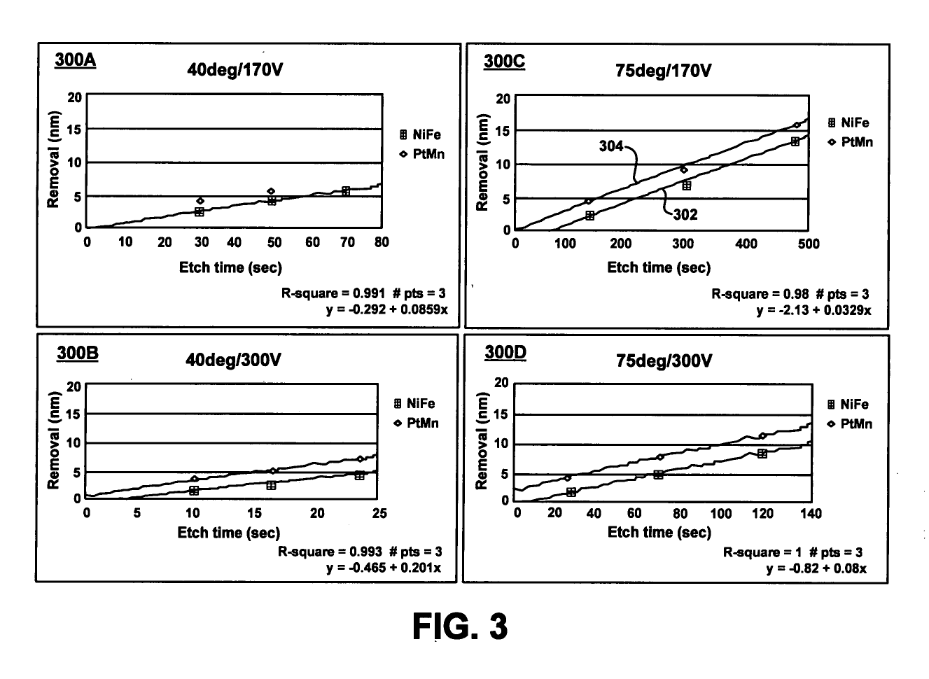

FIG. 3 depicts several graphs 300A, 300B, 300C, 300D illustrating Argon (Ar) sputter etch at different glancing angles and beam voltages that were used during sputter etch cleaning of coupons, according to various embodiments of the present invention. The coupons included a typical NiFe permalloy with 81 wt % Ni and 19 wt % Fe, the thickest layer of the free layer stack, and PtMn prepared using a sensor process. The x axis represents how long the etch was performed in seconds. The y axis represents the amount of material, for NiFe and for PtMn, removed in nanometers.

The IB sputter etch cleaning for graph 300A was performed at 40 degrees and with a beam voltage of 170 volts (V). The sputter etch cleaning for graph 300B was performed at 40 degrees with a beam voltage of 300 V. The sputter etch cleaning for graph 300C was performed at 75 degrees with a beam voltage of 170 V. The sputter etch cleaning for graph 300D was performed at 75 degrees with a beam voltage of 300V.

The coupon study demonstrated, with various pre-etch conditions, that surface effect was a major contributor to the difference in the etch rate. For example, referring to graph 300C, the sputter removal of PtMn represented by line 302 is always more than that of NiFe represented by line 304 at any given time along the x-axis. Further, the slope of lines 302 and 304 is approximately the same. The etch removal difference is traced back to the onset of the etch, intercept at time zero (x=0). This indicates that some reagent caused etching to be performed quickly at the surface of the PtMn 202. Once the reagent was used up, the rate at which the PtMn was etched was the same as the rate that the NiFe was etched as can be seen by the slope of the lines 302 and 304. As will become more evident, the research determined that the reagent was hydrogen, according to one embodiment.

Referring to graphs 300C and 300D, the rate at which material was removed from the NiFe and PtMn appeared to be approximately the same for glancing angle of 75 degrees. Referring to graphs 300A and 300D, the results for glancing angle 40 degrees was inconclusive, however, the results did not contradict the assessment that the rate difference was mainly due to surface effect.

The surface of material made of platinum (Pt) absorbs unsaturated hydrocarbon. Hydrogen and platinum can form an activated complex, referred to herein as Pt—H, with surface diffusivity as high as 500 times more than platinum surface self-diffusion. Much less external activation energy is required to overcome the bonding energy barrier associated with an activated complex Pt—H in order to dislodge surface molecules from adjacent molecules.

For example, an Ar ion bombardment used in a sputter etch process can be used to provide the external activation energy. In a slider air bearing surface (ABS) carbon overcoat process with ion beam DLC, CxHy, such as CH₄, C₂H₂, or C₂H₄, is typically used as a precursor gas. A C—H ion beam process can provide a lot of unsaturated C—H. Therefore, an H-containing ion beam process is likely to result in an activated complex, such as Pt—H, which may have been formed from Pt or PtMn among other things. This problem is generic to DLC since DLC in general conventionally uses hydrogen to stabilize SP3 bond for diamond-like properties. The source of the high Pt concentration could be due to oxidation of Mn or simply inherent Pt—Mn nonstoichiometry.

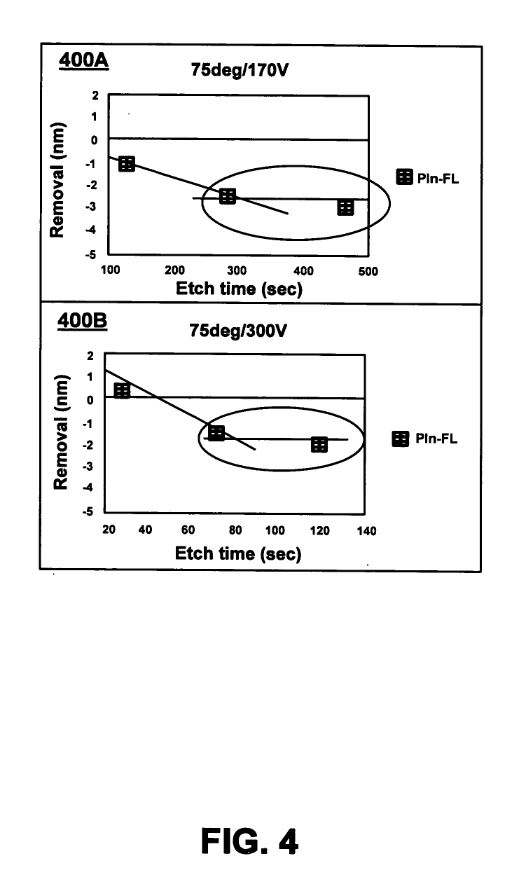

FIG. 4 depicts two graphs 400A and 400B illustrating different glancing angles and beam voltages that were used during sputter etch cleaning of real production sliders, according to various embodiments of the present invention. The x axis for both graphs 400A, 400B is the amount of time the etch was performed in seconds. The y axis for both graphs 400A, 400B depicts the elevation difference between the free-layer (mostly NiFe) and pinned layer (PtMn) as measured by atomic force microscope (AFM). AFM is a well known technique to measure, for example, nano-surface topographies. The pinning layer and the free layer were used as references for measuring the amount of material that was removed.

The sputter etch cleaning for graph 400A was performed at 75 degrees with a beam voltage of 170 V. The sputter etch cleaning for graph 400B was performed at 75 degrees with a beam voltage of 300V.

The “real slider study” verified the “surface effect” phenomena, for example, by measuring pole tip nanotopography using AFM. The production sliders were etched in the same processing run as the coupons, referring to FIG. 3.

The results from etching the real sliders verified that at 75 degree glancing angle the PtMn erosion relative to free layer erosion settled to a constant, for example, as indicated by the flat lines from approximately etch time 300 seconds in graph 400A and from approximately etch time 80 seconds in graph 400B. According to one embodiment, the difference in erosion between the pinning layer and the free layer is approximately zero at approximately 40 seconds of etch time as depicted in graph 400B.

However, the set up and results from the coupon study and the real slider study were different in a number of ways. One, the study with real sliders took longer than the study with the coupons before the difference between the amount etched from the pinning layer and the free layer became constant. Two, GMR structures (182) of the real sliders were made of multi-material stacks rather than NiFe. Three, sputter etch clean etches film cross sections for real sliders, while “coupon” etches “coupon” surface. Four, the surfaces of the real sliders were nano-workhardened from lapping perhaps resulting in them being amorphized near the surface. Number four may directly contribute to the “surface thickness” which could be distinctively different from that of a virgin coupon.

Although how the coupon approximation contribute to the differences in the results between the coupon and the real slider study may not be known at this time, the research was aimed at reproducing the results in order to analyze the results, to determine the problem(s), and to find solutions to the problem(s).

### Solutions to the Problem

It has been found, according to one embodiment, that surface H—C “contamination” is a problem. Further, it has been found that a near zero difference in erosion between the pinning layer and the free layer at approximately 40 seconds of etch time can be accomplished as depicted in graph 400B, according to one embodiment. This enabled the formulation of several solutions, according to various embodiments, as follows. One solution was to minimize the presence of hydrogen. In one example, H₂O partial pressure can be minimized during the DLC process by running a cryopump before the DLC process. Water and H—C in an H—C plasma are potential sources of hydrogen. By turning on a cryopump, water partial pressure can be reduced 1 to 2 orders of magnitude. In a second example, a root blower can be used to minimize the presence of hydrogen. Similarly, a sputter-ion pump may even be better than a cryopump to reduce residual hydrogen. A second solution involved performing sputter etch cleaning at approximately 75 degree angle using approximately 300V for approximately 40 seconds as depicted in graph 400B

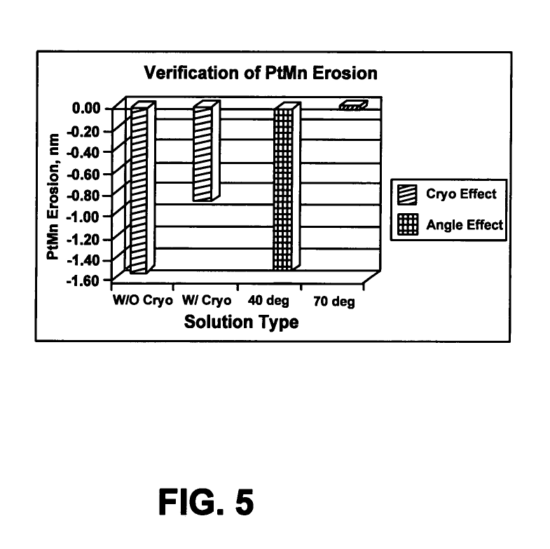

FIG. 5 compares results obtained from the conventional art and various embodiments of the present invention. AFM was used to measure erosion of a pole tip element made of PtMn. FIG. 5 compares results using a cryopump to minimize the presence of hydrogen to the conventional art that does not use a cryopump. FIG. 5 also compares results using 75 degree glancing angle to 40 degree glancing angle after 40 seconds of sputter etch cleaning. The amount of PtMn erosion using a cryopump was approximately half the amount of PtMn erosion without a cryopump. The amount of PtMn erosion using 75 degree glancing angle was nearly zero.

Further, if all C—H sources could be eliminated, then the research indicates that PtMn erosion can be significantly reduced if not eliminated. Therefore, according to one embodiment, a hydrogen-free air bearing surface carbon overcoat (ABSCOC) process can be used, such as by filtered cathodic arc technique or forming the overcoat out of a hydrogen free material such as silicon nitride (SiNx).

### Methods of Forming a Head with Reduced Pole Tip Recession

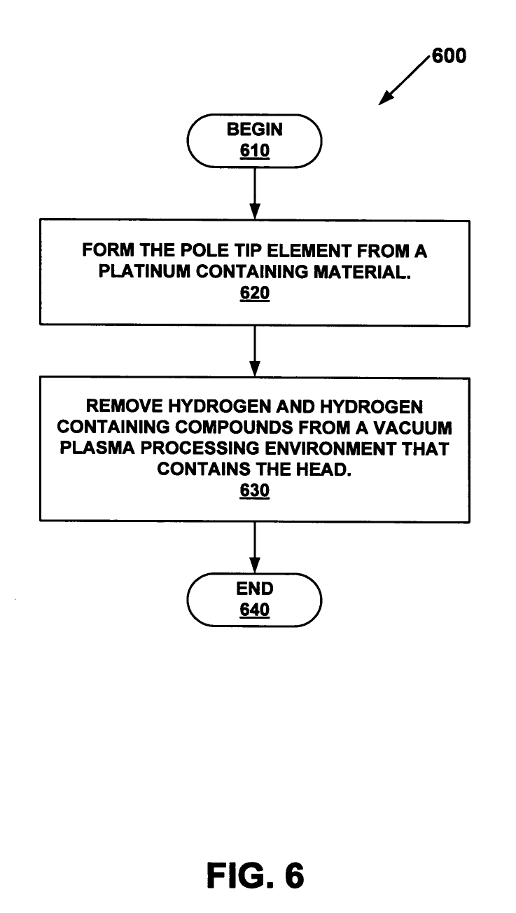

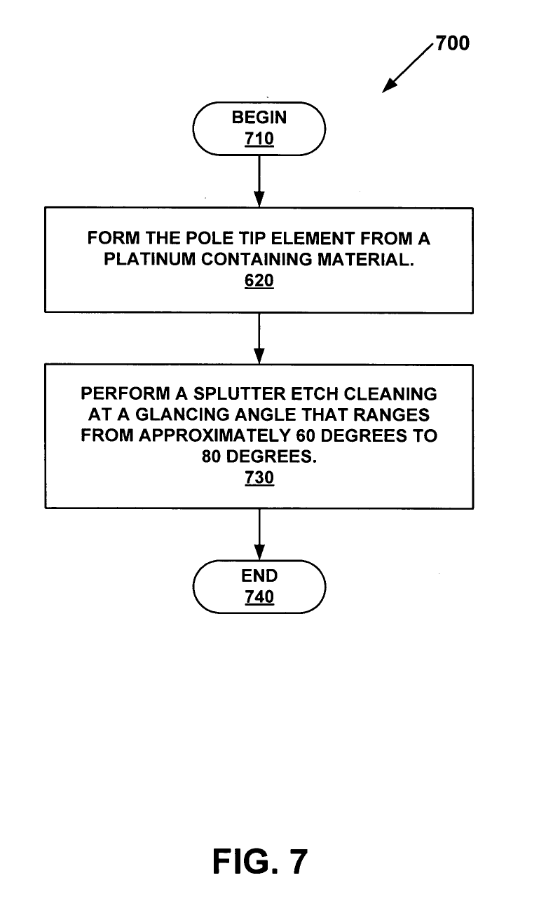

FIG. 6 depicts a flowchart 600 for a method of forming a head with reduced pole tip recession, according to one embodiment, and FIG. 7 depicts a flowchart 700 for another method of forming a head with reduced pole tip recession, according to another embodiment. Although specific steps are disclosed in flowcharts 600, 700, such steps are exemplary. That is, embodiments of the present invention are well suited to performing various other steps or variations of the steps recited in flowcharts 600, 700. It is appreciated that the steps in flowcharts 600, 700 may be performed in an order different than presented, and that not all of the steps in flowchart 600, 700 may be performed.

In step 610, the process of forming a head with reduced pole tip recession begins. As will become more evident, according to one embodiment, the process of forming a head with reduced pole tip recession by removing hydrogen and hydrogen containing compounds from an environment results in a head with a pole tip topography that is closer to being planarized than what conventional techniques provide.

In step 620, the pole tip element is formed from a platinum containing material. For example, a pole tip element may be formed out of PtMn. The pinning layer, which is a part of the pole tip element, in the GMR sensor may be made out of PtMn. According to one embodiment, once the read and write elements associated with read write heads are fully built in the wafer and packaged into an Al₂O₃ overcoat, the wafer can be diced into sliders that have air bearing surfaces.

In step 630, hydrogen and hydrogen containing compounds are removed from vacuum plasma processing environment that contains the head so that an amount of material removed from the pole tip element and an amount of material removed from other non-platinum containing elements associated with the head are approximately the same. For example, a DLC protective coating can be deposited onto the air bearing surfaces of the sliders. A sputter etch clean can be performed prior to the DLC deposition. Hydrogen and hydrogen containing compounds is removed from an environment that the head will be processed in, such as a sputter etch. In this case, an example of an environment is a vacuum plasma processing environment that can be used for the sputter etch. The pole tip is unprotected while it is in the vacuum plasma processing environment. As will become more evident, by removing hydrogen and hydrogen containing compounds an amount of material that is removed from the platinum containing pole tip element and an amount of material that is removed from other non-platinum containing elements associated with the head are approximately the same, according to one embodiment. The platinum-containing pole tip element may be the pinning layer, and the non-platinum containing elements may be reference layers associated with the GMR structure.

As already stated, according to one embodiment, once the read and write elements are built in the wafer and packaged into an Al₂O₃ overcoat, the wafer can be diced into sliders. The read write heads can be lapped and micro-machined using ion milling and reactive ion etching to form the air bearing surfaces. Prior to being put into a vacuum for the DLC process, the materials that the read heads are made out of is inevitably exposed to ambient moisture and hydro-carbon. Therefore hydrogen can be present as surface contaminant as well as trapped in the read head as trace contaminant. The read head is placed in a vacuum at approximately room temperature, for example. However, hydro-carbon surface contaminant may not be volatile, and the hydrogen partial pressure in the vacuum may not be as low as desired. According to one embodiment, the desired partial pressure is approximately 10E-8 mBar. It was discovered through research that hydrogen interacts with a platinum containing material to form an active complex that is easily etched.

Another source of hydrogen is the precursor gas typically used for DLC. Hydrogen is an element that is used to ensure diamond-like material properties, and therefore is incorporated into the processing plasma by conventional designs. Typically, during a run a sputter etch cleaning is performed then some DLC is deposited. When the next run is performed residual hydrogen from the previous run will be present to interact with the platinum containing material.

In order to minimize and if possible to prevent hydrogen interacting with the PtMn to form an active complex Pt—H on the surface 202, hydrogen and hydrogen containing compounds are removed from the environment, e.g., the vacuum that the head is placed into for sputter etch cleaning and DLC deposition. For example, a cryopump or a root blower can be used to reduce or possibly eliminate hydrogen and hydrogen containing compounds from the vacuum environment that contains the head. In another example, hydrogen and hydrogen containing compounds can be reduced or eliminated by using a hydrogen free air bearing surface carbon overcoat process to form an overcoat associated with the head. Filtered cathodic arc carbon is an example of a hydrogen free air bearing surface carbon overcoat process. Forming the overcoat from an alternative hydrogen-free material that offers properties similar DLC, such as SiNx, is another example of a hydrogen free alternative air bearing surface overcoat process.

In step 640, the process stops. As can be seen from the description of flowchart 600, according to one embodiment, the process of forming a head with reduced pole tip recession by removing hydrogen and hydrogen containing compounds from an environment results in a head with nearly planarized pole tip topography. For example, since the formation of the active complex was minimized or possibly eliminated, an amount of material that is removed from the platinum-containing pole tip element and an amount of material that is removed from the adjacent neighboring elements, which do not contain platinum, are approximately the same, according to one embodiment. According to one embodiment, after the method described by flowchart 600 has completed, the process moves to other down stream manufacturing processes that are well known in the prior art.

FIG. 7 depicts a flowchart 700 for another method of forming a head with reduced pole tip recession, according to another embodiment. For example, flowchart 700 describes, according to one embodiment, reducing pole tip recession by performing sputter etch cleaning at a glancing angle, as will become more evident.

In step 710, the process begins.

In step 620 of FIG. 7, the pole tip element is formed from a platinum containing material as previously described above.

In step 730, a sputter etch cleaning that affects the air bearing surface of the pole tip is performed at a glancing angle that ranges from approximately 60 to 80 degrees so that an amount of material removed from the pole tip element and an amount of material removed from a GMR structure are approximately the same. The GMR structure is adjacent to the pole tip element, according to one embodiment. The pole tip element is a GMR pinning layer, according to embodiment. The GMR structure is a free layer, according to one embodiment.

As seen in graph 400B, a near zero difference in erosion between the pinning layer and the free layer at approximately 40 seconds of etch time can be accomplished.

In step 740, the process ends. As can be seen from the description of flowchart 600, according to one embodiment, the process of forming a head with reduced pole tip recession by removing hydrogen and hydrogen containing compounds from an environment results in a head with planarized pole tip topography. According to one embodiment, after the method described by flowchart 600 has completed, the process moves to other down stream manufacturing processes that are well known in the prior art.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of forming a head with reduced pole tip recession, the method comprising:
forming pole tip element from a platinum containing material; and
removing hydrogen and hydrogen containing compounds during a diamond like carbon (DLC) processing from a vacuum plasma processing environment that contains the head so that an amount of material that is removed from the pole tip element and other non-platinum containing elements associated with the head are approximately the same.

2. A method as recited in claim 1, wherein the removing of the hydrogen and the hydrogen containing compounds from the environment further comprises:
using a device selected from a group consisting of a cryopump, a root blower, and sputter-ion pump to remove the hydrogen from the vacuum plasma processing environment.

3. A method as recited in claim 1, wherein the removing of the hydrogen and the hydrogen containing compounds from the environment further comprises:
using a hydrogen free air bearing surface carbon overcoat process to form an overcoat associated with the head.

4. A method as recited in claim 3, wherein the hydrogen free air bearing surface carbon overcoat process is selected from a group consisting of a filtered cathodic arc and forming the overcoat from a hydrogen free material.

5. A method as recited in claim 1, further comprising:
performing a sputter etch cleaning on an air bearing surface of the head at a glancing angle that ranges from approximately 60 degrees to 80 degrees so that an amount of material removed from the pole tip element and an amount of material removed from the other non-platinum containing elements are approximately the same.

6. A head with reduced pole tip recession made by the method comprising:
a pole tip element having a platinum containing material; and
etched in a vacuum plasma processing environment during a diamond like carbon (DLC) processing removed of hydrogen and hydrogen containing compounds so that an amount of material that is removed from the pole tip element and other non-platinum containing elements associated with the head are approximately the same.

7. A head as recited in claim 6, wherein the hydrogen and hydrogen containing compounds are removed from the vacuum plasma processing environment using a device selected from a group consisting of a cryopump, a root blower, and a sputter-ion pump to remove the hydrogen from the environment.

8. A head as recited in claim 6, wherein the pole tip element is a GMR antiferromagnetic pinning layer and the non-platinum containing elements are adjacent to a free layer associated with the head.

9. A head as recited in claim 6, wherein the hydrogen and the hydrogen containing compounds are removed from the vacuum plasma processing environment using a hydrogen free air bearing surface carbon overcoat process to form an overcoat associated with the head.

10. A head as recited in claim 9, wherein the hydrogen free air bearing surface carbon overcoat process is selected from a group consisting of a filtered cathodic arc carbon and forming the overcoat from a hydrogen free material.

11. A head as recited in claim 6, wherein the head is etched using a sputter etch cleaning on an air bearing surface of the head at a glancing angle that ranges from approximately 60 degrees to 80 degrees so that an amount of material removed from the pole tip and an amount of material removed from a free layer are approximately the same.

12. A method of forming a head with reduced pole tip recession, the method comprising:
forming the pole tip element from a platinum containing material; and
performing a sputter etch cleaning that affects the air bearing surface of the pole tip at a glancing angle that ranges from approximately 60 degrees to 80 degrees so that an amount of material removed from the pole tip element and an amount of material removed from a giant magneto-resistive (GMR) structure are approximately the same, wherein the GMR structure is adjacent to the pole tip element.

13. A method as recited in claim 12, wherein the step of performing of the sputter etch cleaning further comprises:
performing the sputter etch cleaning at a beam voltage that ranges from approximately 170 volts (V) to 300 V.

14. A method as recited in claim 12, wherein the pole tip element is a pinning layer and the GMR structure is a free layer.

15. A method as recited in claim 12, wherein the step of performing of the sputter etch cleaning further comprises:
performing the sputter etch cleaning at least approximately 40 seconds.

16. A head with reduced pole tip recession made by the method comprising:
forming the pole tip element from a platinum containing material; and
performing a sputter etch cleaning that affects the air bearing surface of the pole tip at a glancing angle that ranges from approximately 60 degrees to 80 degrees so that an amount of material removed from the pole tip element and an amount of material removed from a giant magneto-resistive (GMR) structure are approximately the same, wherein the GMR structure is adjacent to the pole tip element.

17. A head as recited in claim 16, wherein the step of performing of the sputter etch cleaning further comprises:
performing the sputter etch cleaning at a beam voltage that ranges from approximately 170 volts (V) to 300 V.

18. A head as recited in claim 16, wherein the pole tip element is a pinning layer and the GMR structure is a free layer

19. A head as recited in claim 16, wherein the step of performing of the sputter etch cleaning further comprises:
performing the sputter etch cleaning for at least approximately 40 seconds.

20. A head as recited in claim 16, wherein the method further comprises:
removing hydrogen and hydrogen containing compounds from an environment that contains the head.
